(19) United States
(12) Patent Application Publication
(10) Pub. No.: US 2009/0204920 A1
(43) Pub. Date: Aug. 13, 2009

(54) Image Browser

(76) Inventors: Aaron John Beverley, Queensland (AU); Laurence Crew, New South Wales (AU); Jonathon Anthony Duhig, New South Wales (AU); Timothy Mark Morris-Yate, New South Wales (AU); Louis Pan, New South Wales (AU); Andrew John Shellshear, New South Wales (AU); Steven David Webster, New South Wales (AU); Kevin Mun Choong Tham, New South Wales (AU)

Correspondence Address: FITZPATRICK CELLA HARPER & SCINTO, 30 ROCKEFELLER PLAZA, NEW YORK, NY, 10112, US

(21) Appl. No.: 11/995,491

(22) PCT Filed: Jun. 15, 2006
(86) PCT No.: PCT/AU06/00831

§ 371 Date: Jun. 18, 2008

(30) Foreign Application Priority Data
Jul. 14, 2005 (AU) 2005203074

(51) Int. Cl. G06F 3/048; G06T 1/00

(52) U.S. Cl. 715/768; 715/838; 715/848

(57) ABSTRACT

A method of browsing images in an image collection using a processing system (101). The method includes having the processing system (101) cause a representation of a number of images to be displayed, the representation including the number of images arranged in an image ring (110). The image ring is configured to have a size determined by at least one of the number of images and the size of the images in the image ring.

### FIELD OF THE INVENTION

The present invention relates to a method and apparatus for displaying images and in particular to displaying images using an image ring.

### DESCRIPTION OF THE BACKGROUND ART

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

With the advent of image scanners, video capture cards and digital still and video cameras, it is common for people to store photographs, video sequences, and other images on personal computers and other computer related devices. As a result there is a need for users of these devices to be able to access their images for viewing, sharing and organisation.

Consequently, a range of software applications and dedicated devices has been created to aid in the tasks of viewing, sharing and organising collections of images. Typically, when such applications are used for viewing a collection of images on a screen, the images are laid out in a 2 dimensional grid of small images known as a ‘thumbnail grid’.

However, such arrangements suffer from a number of drawbacks. For example, when browsing a collection of images using a limited input device such as a remote control, rather than a precise pointing device such as a mouse, the thumbnail grid can become difficult to operate since multiple modes of operation including selection, scrolling and zooming are required. Furthermore when a large collection of images is being browsed, the thumbnail grid becomes less effective as additional scrolling or paging is required, or the size of the thumbnails is reduced.

In many cases the approach to handling large image collections in a thumbnail grid browser is to divide the collection into folder hierarchies represented as a tree view, for example. This approach however creates additional complexity and control problems especially for limited input devices.

Therefore it is advantageous to provide an image browsing method that combines simple control with reduced modality by combining browsing, viewing and selection into a single mode, and the ability to effectively browse very large image collections.

### SUMMARY OF THE PRESENT INVENTION

It is an object of the present invention to substantially overcome, or at least ameliorate, one or more disadvantages of existing arrangements.

In a first broad form the present invention provides a method of browsing images in an image collection, wherein the method comprises, in a processing system, causing a representation of a number of the images to be displayed, the representation including the number of images arranged in an image ring, the image ring having an image ring size determined by at least one of:
a) the number of images; and,
b) the size of images in the image ring.

Typically the method includes, in the processing system:
a) selecting the number of images from the image collection;
b) determining the size of each of the selected images; and,
c) determining the image ring size using the size of each selected image.

Typically the method includes, in the processing system:
a) generating the representation by arranging the selected images in the image ring in accordance with the determined image ring size; and,
b) transferring representation signals to a display thereby causing the display to display the representation.

Typically the method includes, in the processing system:
a) receiving at least one input command via an input device; and,
b) manipulating the representation of the image ring in accordance with the at least one input command.

Typically the method includes, in the processing system, manipulating the representation by at least one of:
a) rotating the image ring;
b) altering an image ring zoom level; and,
c) altering an image ring viewing perspective.

Typically the method includes, in the processing system, determining the zoom level based on at least one of:
a) a time since a directional control button is actuated; and,
b) a rotational velocity of the image ring.

Typically the method includes, in the processing system, applying a dampening function to changes in zoom level in response to changes in the rotational velocity of the image ring.

Typically the method includes, in the processing system:
a) receiving input commands via at least one directional control button;
b) rotating the image ring by at least one of:
   i) in a first mode, one image per button press; and,
   ii) in a second mode, at a rotational velocity dependent on the duration of a button press.

Typically the method includes, in the processing system, selecting the operational mode dependent on the elapsed time between depressing and releasing the directional control button.

Typically the method includes, in the processing system:
a) receiving input commands via at least one input dial;
b) rotating the image ring by at least one of:
   i) a rotational velocity determined at least in part on the rotational velocity of the input dial; and,
   ii) a rotational velocity determined at least in part on the rotational position of the input dial.

Typically the method includes, in the processing system, altering at least one of a viewing perspective and a zoom level depending on the size of the image ring

Typically the representation includes a focus position, and wherein the method comprises:
a) displaying a focus image, the focus image being an image provided at the focus position; and,
b) changing the focus image by rotating the image ring.

Typically the method includes, in the processing system, altering the focus position depending on a rotational velocity of the image ring.

Typically the focus position is represented by a focus indicator, and wherein the method includes, in the processing system, altering at least one property of the focus indicator depending on relative alignment between an image and the focus indicator.

Typically the method includes, in the processing system, altering a focus indicator visibility such that the focus indicator has at least one of:
a) an increased visible weight when the image ring is rotating; and,
b) a reduced visible weight when the focus image is aligned with the focus indicator.

Typically the method includes, in the processing system, altering dimensions of the focus indicator in accordance with dimensions of the focus image.

Typically the image is a video sequence, and wherein the method includes, in the processing system, and when the video sequence is in the focus position:
a) displaying the image as a moving image sequence; and,
b) providing audio output associated with the image sequence.

Typically the method includes, in the processing system:
a) scaling each image such that:
   i) a first dimension of each image is constant; and,
   ii) a second dimension of each image depends on the aspect ratio of the image; and,
b) generating the representation using the scaled images.

Typically the method includes, in the processing system, determining the image ring size based on the second dimension of each image.

Typically the method includes, in the processing system, determining the image ring size based on the average aspect ratio of the images in the image ring.

Typically the method includes, in the processing system, selecting the number of images based on the average aspect ratio of the images in the image ring.

Typically the method includes, in the processing system:
a) determining a second number of images from the image collection;
b) arranging the second number of images in a virtual image ring, the virtual image ring being connected to the image ring at a crossover point, such images are transferred between the virtual image ring and the image ring as the images move through the crossover point.

Typically the method includes, in the processing system, adjusting the position of the crossover point depending on a rotational velocity of the image ring.

Typically the method includes, in the processing system, altering the number of images in the image ring depending on the total number of images in the image collection.

Typically the method includes, in the processing system, displaying the images in the image ring in a common orientation.

Typically the method includes, in the processing system, reversing images as the images are transferred between front and back portions of the image ring.

Typically the method includes, in the processing system, altering at least one image property depending on at least one of:
a) a position of the image in the image ring; and,
b) a rotational velocity of the image ring.

Typically the at least one image property includes at least one of:
a) an image opacity; and,
b) an image obscurity.

In a second broad form the present invention provides apparatus for browsing images in an image collection, wherein the apparatus includes a processing system for causing a representation of a number of the images to be displayed, the representation including the number of images arranged in an image ring, the image ring having an image ring size determined by at least one of:
a) the number of images; and,
b) the size of images in the image ring.

Typically the apparatus includes an input device, the processing system being for:
a) receiving at least one input command via an input device; and,
b) manipulating the representation of the image ring in accordance with the at least one input command.

Typically the input device communicates wirelessly with the processing system.

Typically the input device is a remote control.

Typically the input device includes, at least one of:
a) a first input button for causing the processing system to rotate the image ring in a first direction;
b) a second input button for causing the processing system to rotate the image ring in a second direction;
c) an input dial for causing the processing system to rotate the image ring at a velocity determined by the rate of rotation of the dial; and,
d) an input dial for causing the processing system to rotate the image ring at a velocity determined by the rotational position of the input dial.

Typically the processing system is for transferring representation signals to a display thereby causing the display to display the representation, the display being a television.

Typically the apparatus performs the method of the first broad form of the invention.

In a third broad form the present invention provides a computer program product for browsing images in an image collection, the computer program product being formed from computer executable code which when executed on a suitable processing system causes a representation of a number of the images to be displayed, the representation including the number of images arranged in an image ring, the image ring having an image ring size determined by at least one of:
a) the number of images; and,
b) the size of images in the image ring.

Typically the computer program product causes the processing system to perform the method of the first broad form of the invention.

### BRIEF DESCRIPTION OF THE DRAWINGS

An example of the present invention will now be described with reference to the accompanying drawings, in which:—

FIG. 1A is a schematic diagram of an example of apparatus for viewing images using a user interface;

FIG. 1B is a flowchart of an example of the process of viewing images using the apparatus of FIG. 1A;

FIG. 2A is a schematic diagram of an example of the user interface of FIG. 1A in a zoomed out state;

FIG. 2B is a schematic diagram of an example of the user interface of FIG. 1A in an intermediate zoom state;

FIG. 2C is a schematic diagram of an example of the user interface of FIG. 1A in a zoomed in state;

FIG. 3 is a schematic diagram of an example of the relative positions of the image ring and a virtual camera at various zoom levels;

FIG. 4A is a schematic diagram of an example of the use of translucent tiles to represent images in the rear section of the image ring;

FIG. 4B is a schematic diagram of an example of the use of back-to-back images in the rear section of the image ring;

FIG. 5 is a schematic diagram of an example of the image ring where the number of images is increased and the size of the image ring is correspondingly increased;

FIG. 6A is a schematic diagram of an example of the use of a cross over image ring;

FIG. 6B is a schematic diagram of a second example of the use of a cross over image ring;

FIG. 7 is a schematic diagram of an example of the scaling of images with variable aspect ratios to a fixed height within the image ring;

FIGS. 8A and 8B are a flowchart of an example the process of generating and manipulating an image ring;

FIG. 9A is a schematic diagram of a first example of a control device to enable manipulation of the presented image ring;

FIG. 9B is a schematic diagram of a second example of a control device to enable manipulation of the presented image ring;

FIG. 10A is a schematic diagram of an example of a state transition diagram representing the control of the user interface using the control device of FIG. 9A or FIG. 9B;

FIG. 10B is a schematic diagram of an example of a flow chart of events while in the ‘Decel’ state of FIG. 10A;

FIG. 10C is a schematic diagram of an example of a state transition diagram representing the control of the user interface using dial of the control device of FIG. 8;

FIG. 11 is a schematic diagram of an example of a graph illustrating a zoom level dampening function;

FIGS. 12A to 12C are schematic diagrams of examples for counteracting the effects of focus lag;

FIGS. 13A and 13B are schematic diagrams of examples of the dependence on image ring velocity of the visible weight of a focus indicator;

FIG. 13C is a schematic diagram of an example of the dependence of the dimensions of a focus indicator on image size; and,

FIG. 14 is a schematic diagram of an example of a processing system.

### DETAILED DESCRIPTION INCLUDING BEST MODE

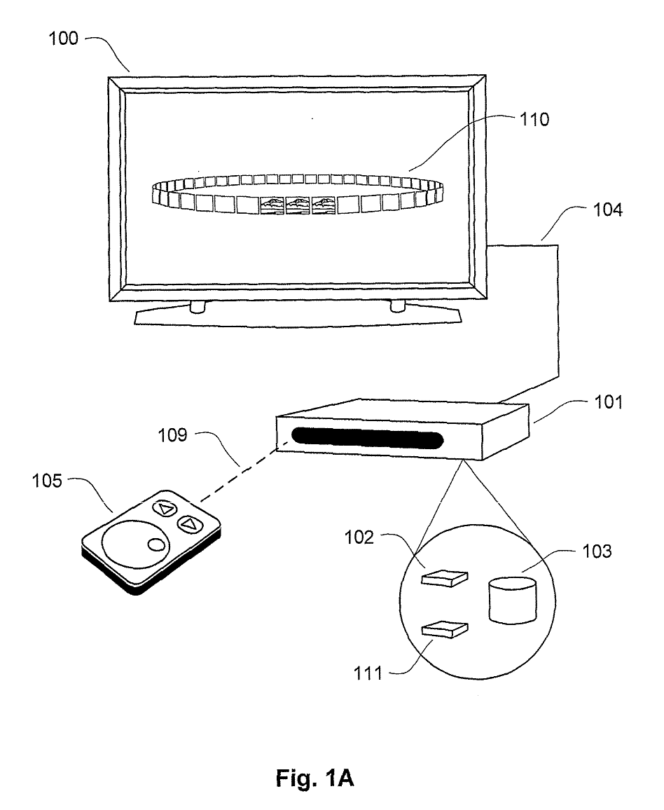

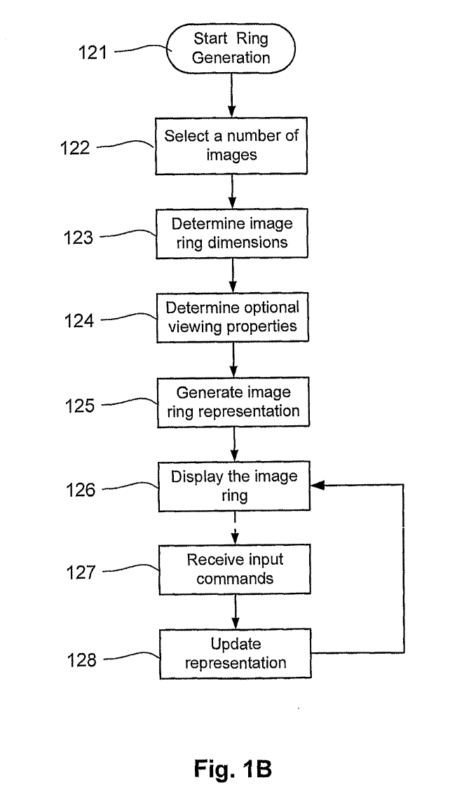

An example of a system for browsing a collection of images, such as photos, illustrations, videos, animations etc, will now be described with reference to FIG. 1A.

In this example, the system includes a display 100, such as a television, connected to a media device 101 by a connector 104. A control device 105 communicates with the media device 101, either wirelessly or via a wired connection, as shown generally by the connection 109, allowing the media device 101 to control the presentation of a user interface 110 on the display 100.

The media device 101 may be any form of device which is capable of receiving input commands and using these to present a user interface on the display, but typically comprises at least a Central Processing Unit (CPU) 102 and a data storage system 103. The media device 101 may additionally contain a Graphics Processing Unit (GPU) 111, which assists in the rendering of a user interface on the display 101. The GPU 111 may support the execution of graphics libraries such as OpenGL.

In some embodiments, the Central Processing Unit (CPU) 102, optional Graphics Processing Unit (GPU) 111 and data storage system 103 may be contained directly within the chassis of the Display 100, thereby eliminating the need for the media device 101 and connector 104.

In use, the data storage system 103 contains a plurality of images represented in digital form, with the CPU 102 operating to cause these to be selectively displayed using the user interface 110.

In use, the user interface 110 presents the images in an image ring formation. A user of the control device 105 is able to control the rotation of the image ring about a central axis, thereby navigating through the collection of images.

In one example, the image ring is circular, or elliptical in shape, and is arranged around a vertical central axis parallel to the Y axis in 3D space, with the images being arranged normal to and equidistant from a flat plane described by X and Z axes. The flat plane is herein referred to as the ‘base plane’ of the image ring.

It will be appreciated that this arrangement is for the purpose of example only. It is also possible to arrange the image ring around a horizontal axis, or any other axis in 3D space, or to arrange the image ring such the items are equidistant from any flat plane or non-flat surface providing the axis intersects the plane or surface at some point. Alternatively the image ring may not be circular but may comprise any closed curve or continuous locus in 3D space.

In conjunction with controlling the rotation of the image ring for navigation purposes, the user of the invention is able to control various viewing properties, such as a zoom level and viewpoint of the image ring. In a zoomed out state, a greater number of images is visible but at the expense of each image being shown smaller; conversely in a zoomed in state as few as one image might be visible but at a larger size allowing the image to be viewed in more detail.

An example of the process of using the apparatus of FIG. 1A to view the user interface 110, and in particular the image ring, will now be described with reference to FIG. 1B.

In particular, the ring presentation process is commenced at step 120, with a number of images being selected for presentation by the CPU 102 at step 121. At step 122, the CPU 102 uses the selected images to determine image ring dimensions, thereby ensuring the selected images can be suitably displayed.

At step 123 the CPU 102 determines a ring position, corresponding to a current rotational orientation of the image ring. At step 124 the CPU 102 determines optional image ring viewing properties, such as a zoom level and a viewing perspective, before generating an image ring representation at step 125. At step 126 the CPU causes the image ring representation to be displayed by the display 100.

At this point the CPU 102 can also operate to receive input commands from the control device 105, using this to update the relative rotational position of the image ring at step 128. The process can then return to step 124 to allow modified image ring viewing properties to be determined with steps 124 to 128 being repeated as required in accordance with received input commands.

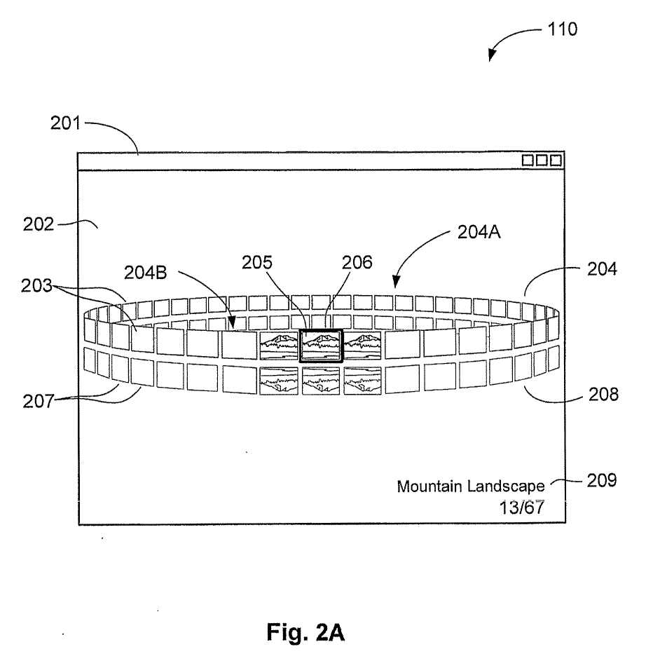

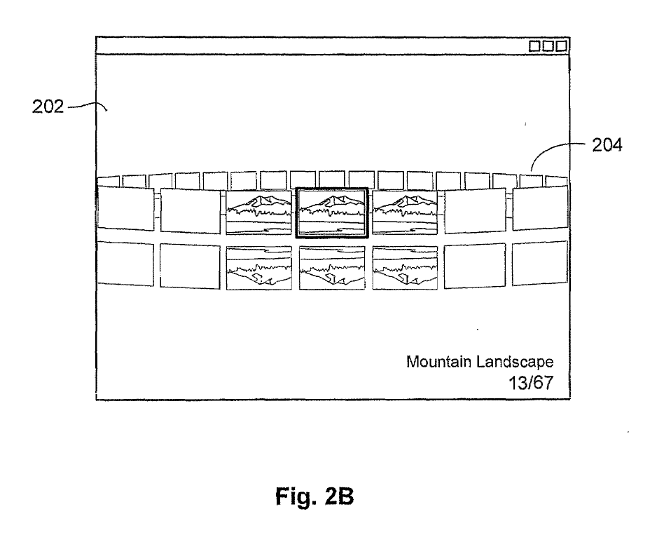

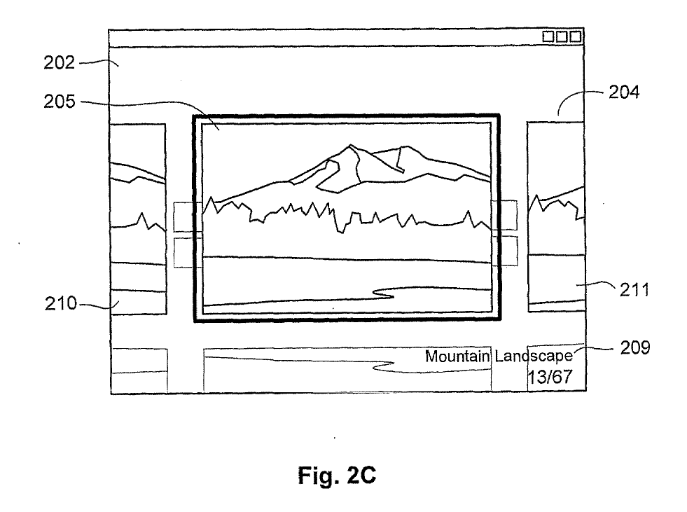

The image ring and some of the associated properties will now be described with respect to FIGS. 2A to 2C.

FIG. 2A is an example of user interface 110, with an image ring 204 arranged in a zoomed out state. In this example, the user interface 110 includes an application window 201 containing a view pane 202. Images 203 belonging to an image collection are arranged in the image ring 204.

For the purpose of clarity, the majority of images 203 in the image ring 204 are represented as plain rectangles in the diagrams. This is for simplicity of the diagrams only and it is to be understood that all or images or other elements comprising the image ring 204 represent actual images, except where otherwise noted.

In one example, the image ring 204 is rendered in perspective projection in 3D. The advantage of rendering in perspective projection is that images 203 at a rear portion 204A of the image ring 204 are able to be viewed without being obscured by the images 203 in a front portion 204B, and in greater numbers than would be possible without the use of perspective.

An optional reflected image ring 208 is provided for visual effect. The reflected image ring comprises reflected images 207, which are copies of the images 203, reflected in a base plane of the image ring 204. The reflected images 207 may be shown in a semi-transparent state or otherwise visually obscured so that the user's focus is not distracted from the images 203 and for additional visual effect.

In one example, the image ring 204 is created as 3D geometry using the OpenGL graphics library and rendered with the assistance of the Graphics Processing Unit (GPU) 111. The images 203 are loaded into graphics memory associated with the GPU 111 as textures and these textures are applied to the 3D geometry that comprises the image ring 204. Since the images are stored as textures in the graphics memory and due to the operation of the GPU, it is possible to have additional copies of the images shown on the screen without incurring any significant performance overhead.

However, it will be appreciated that any suitable mechanism for displaying and manipulating images may be used.

In the example shown in FIG. 2A, image 205 is considered to be in focus and selected. This image is herein referred to as the ‘focus image’. In one example, the focus image 205 is always located at a position on the view pane 202 corresponding to the front and centre of the image ring 204. The position of the focus image 205 on the view pane 202 is referred to as the ‘focus position’.

In one example, the focus position is visually indicated by a border or frame 206. However, visual indication is optional and may take a variety of forms or be indicated solely by the position on the view pane 202. Since the focus position is constant, rotating the image ring causes the focus image 205 to change as the images 203 in the image ring respectively align with the focus position. The visual indicator of the focus position, for example the border or frame 206, is herein referred to as the ‘focus indicator’.

Metadata relating to the current focus image 205 is shown at 209. Metadata may include name, date, size etc. of the focus image, and may also include the ordinal position of the image in the collection and the total number of items in the collection. The metadata is updated whenever the focus image 205 changes, such as when the image ring 204 is rotating.

In the event that the image corresponds to an image sequence, such as a video sequence, it is typical that when the image is first provided in the focus position, the image sequence will commence playback from the first image in the image sequence. Additionally, if audio information is associated with the video sequence, then this is typically also output via a suitable system, such as speakers associated with the display.

When images corresponding to an image sequence are provided in the image ring 204 at positions other than the focus position, the image displayed can be a static image, for example based on one of the images in the image sequence. Alternatively, however, the images sequence as a whole can be presented, depending on the preferred implementation. In this case, the image sequence could be looped so that it repeats once the end of the image sequence is reached. In this example, when the image sequence is presented as the focus image, the image sequence can continue to be displayed from the currently displayed point in the sequence, or can be displayed from an indicated starting point. As a further alternative, image sequences could be displayed as static images whilst the image ring 204 is moving, and as a moving image sequence when the image ring is stationary.

In one example, in the fully zoomed out state, the entire image ring 204 is visible within the view pane 202. In contrast, at an intermediate zoom level as illustrated in FIG. 2B, only part of the image ring 204 is visible, with the image ring 204 being cropped at either side of the view pane 202.

FIG. 2C is an example of the user interface 110 in a zoomed in state. In this example, the image ring 204 is magnified so that focus image 205 substantially fills the view pane 202, with some portion of adjacent images 209 and 210 being still visible. It is an advantage if a portion of at least one adjacent image 203 in each direction of rotation is visible, as this gives the user of the invention an indication of which image 203 will be displayed next when the image ring 204 is rotated.

As shown in the examples of FIGS. 2A to 2C, the position and size of the metadata 209 is not dependent on the zoom level, although this is not essential.

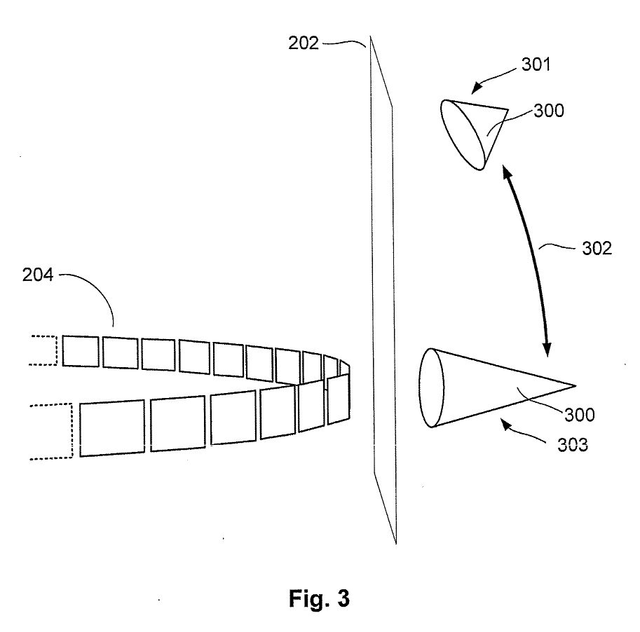

FIG. 3 is a schematic diagram, drawn as a view from the side, showing the relative positions of the image ring 304 and a virtual camera 300 shown at various zoom levels at 301, 303. The view of the image ring 204 in a view pane 202 is determined by the position and zoom factor of the virtual camera 300 and in this example, the relative length of the virtual camera 300 is indicative of the zoom factor.

The virtual camera 300 shown at 301 has a position and zoom factor consistent with the zoomed out state such as that shown in FIG. 2A. Similarly, the virtual camera 300 shown at 303 has a position and zoom factor consistent with the zoomed in state such as that shown in FIG. 2C.

In this example, arrow 302 indicates the movement of the virtual camera 300 as it tilts upwards and/or moves away from the image ring. By simultaneously tilting the virtual camera 300 upwards and reducing its zoom level, the user interface 110 affords a ‘birds eye’ view when in a zoomed out state, thereby maximising the user's ability to perceive the entire image ring 204. Similarly, when the camera 300 is tilted downwards and zoomed in, this provides and a ‘front on’ view, thereby maximising the dominance of the focus image 205 in the view.

The zoom factor, tilt angle and distance of the camera 300 from the image ring 204 all contribute to the point of view of the image ring 204 in the view pane 202. The combination of these factors to yield a particular point of view is herein referred to as the ‘zoom level’

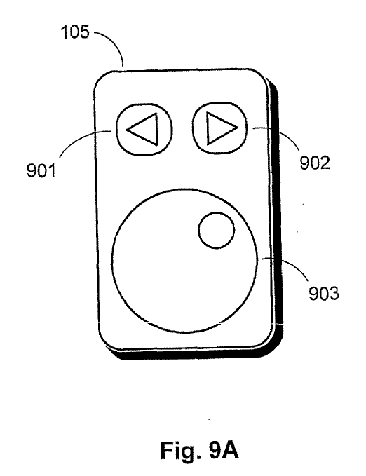

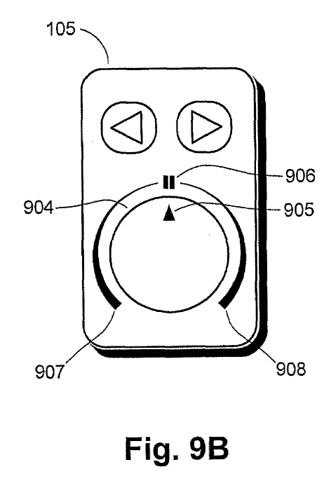

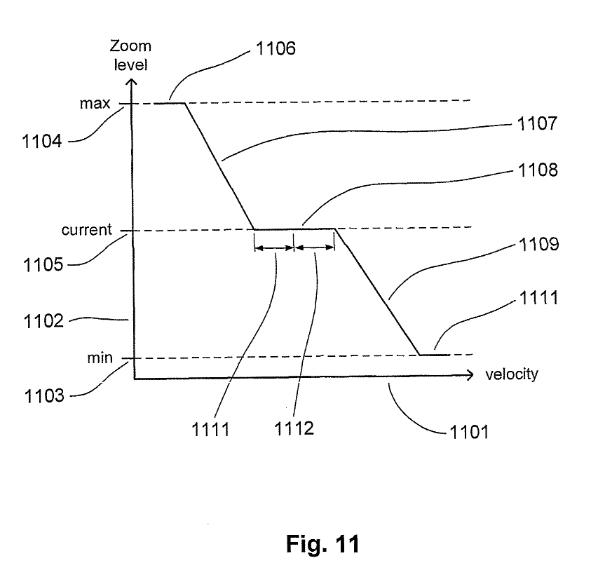

The camera position and zoom factor are controlled indirectly by the user in response to the user's operation of the control device 105, as will be described in further detail with reference to FIGS. 9 to 11.

In FIG. 2A, it is apparent that the images 203 in the rear section 204A of the image ring 204 are being viewed from the ‘inside’ in relation to the images 203 at the front 204B. There are a variety of possibilities of how to represent the ‘inside’ of the images 203. In one example, each image 203 in the image ring 204 is placed on an opaque tile, such that when seeing the tile from the ‘inside’ it appears as the back of the tile, being a regular surface with no indication of the image being visible. This has the advantage of reducing visual clutter that might otherwise distract the user from the images 203 shown in the front portion 204B of the image ring 204.

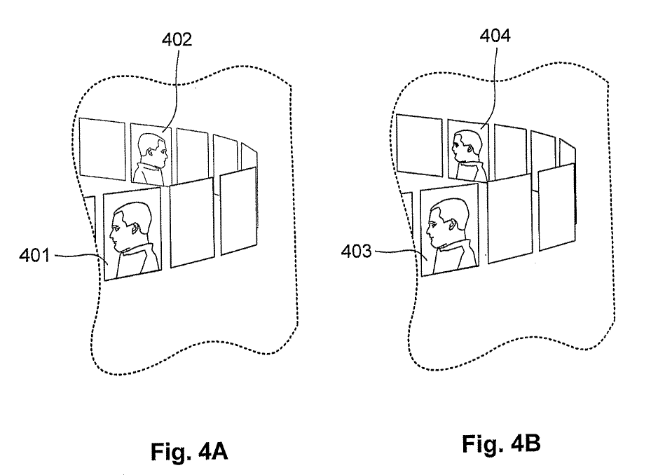

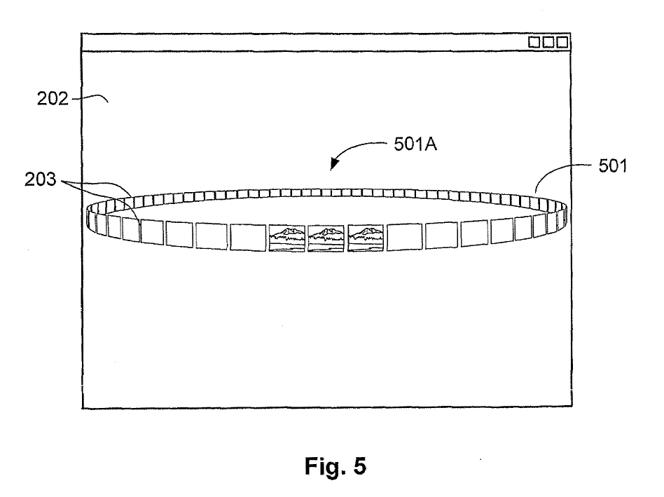

In an alternative example, each image 203 placed on a transparent tile as if it was a slide. As a result, when viewed from the ‘inside’ the back the image 203 will be viewable but in a reverse orientation compared to how it is shown in the front section 204B of the image ring 204. An example of this is shown in FIG. 4A. Thus, in this example, image 401, when viewed in the rear portion 204A of the image ring 204 will appear reversed as shown at 402.

As a further alternative, each image 203 is placed twice, back-to-back on either side of a tile. With this design the image 203 appears in the same orientation whether it is seen in the front portion 204B or rear portion 204A of the image ring 204. An example of this is shown in FIG. 4B in which image 403, when viewed at the rear portion 204A will appear in the same orientation, as shown at 404.

In order to reduce visual clutter when viewing the image 203 on the front portion 204B, at least one property of the images 203 in the rear portion 204A may be altered. This can be achieved, for example, by altering the image opacity so that the images 203 in the rear portion are at least partially faded, or by applying virtual fog to the images 203, to thereby alter image obscurity.

In an enhancement of this technique, the level of obscurement achieved by altering the image property, or properties, can be made dependent on a rotational velocity of the image ring 204. Accordingly, the image opacity and image obscurity can be made to depend on the image ring rotational velocity. In this example, when the image ring 204 is stationary, the level of obscurement in the rear portion 204A is at a maximum level, so as to minimise the distraction of the user from the images 203 shown in the front portion 204B. When the image ring is rotating at its maximum velocity, the level of obscurement of the images 205 in the rear portion 204A is at a minimum, so as to allow the best possible perception of the images 203 as they move towards the front portion 204B.

A collection of images may comprise a variable number of items. Therefore a method is needed for allowing a variation in the number of images in a collection while maintaining an effective geometric arrangement of the image ring. One method is to vary the diameter of the image ring in order to fit the number of items at a given scale.

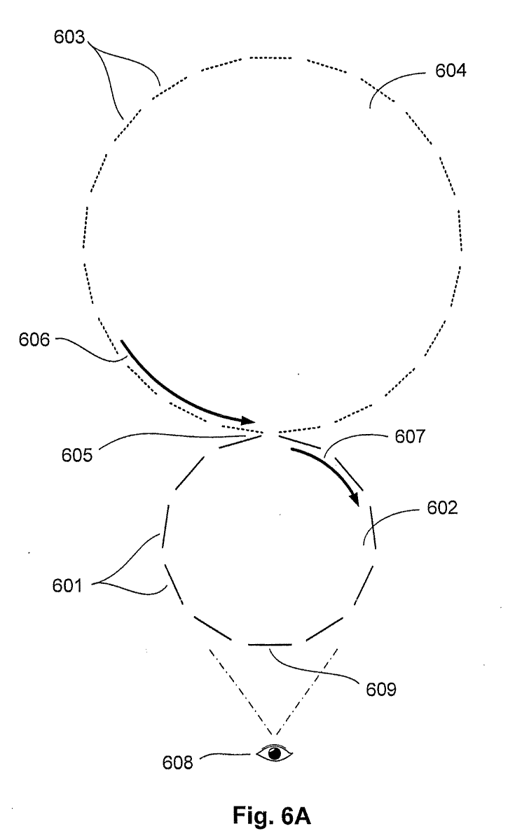

An example of this is shown in FIG. 5A, in which an illustrated image ring 501 of images 203 where the quantity of images is visibly greater than the number of images in the image ring 204 as shown in FIG. 2A. The zoom factor and position of the virtual camera 300 is set such that the image ring 501 fits wholly within the view pane 202 in the zoomed out state.

FIG. 5 highlights that the perspective effect on the images 203 at a rear portion 501A of the image ring 501 is increased as the number of images 203 in the image ring increases. With a very large number of images 203 in the image ring 501, the perspective effect is such that the images 203 in the rear portion 501A become so small that the content of the images 203 cannot be seen. In addition, rendering a very large number of images 203 on the screen simultaneously can cause excessive load on system resources including video RAM.

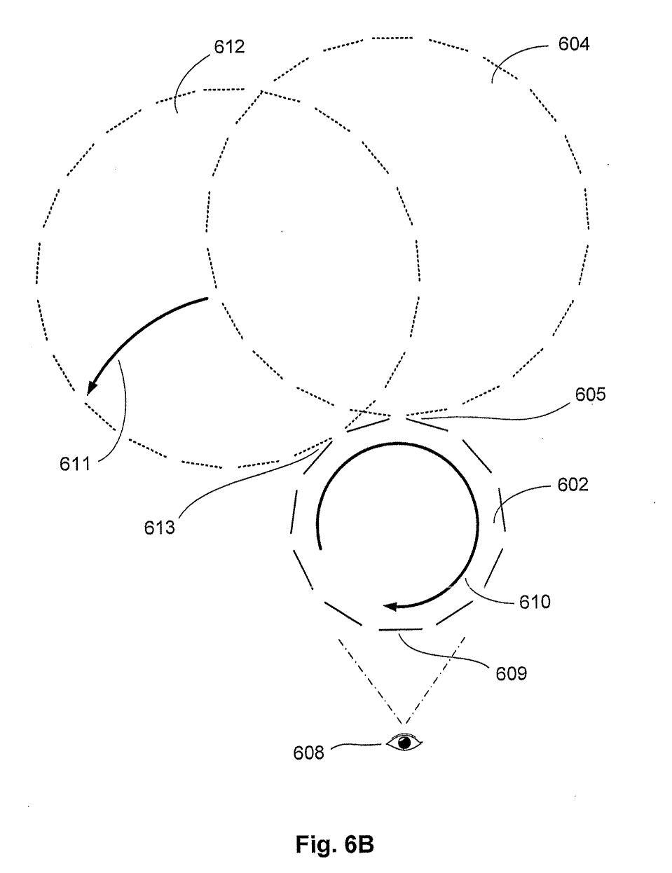

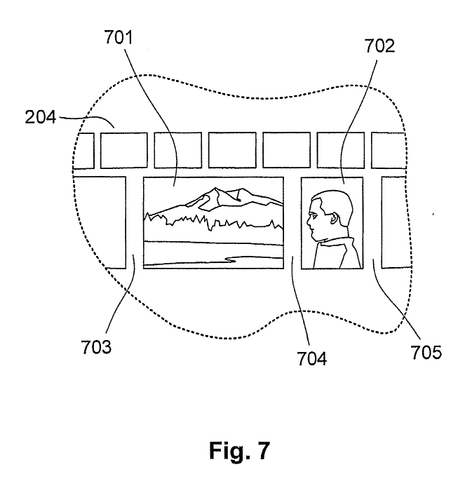

FIG. 6A is an example of a method for allowing a variation in the number of images in the collection, while maintaining a maximum size of the visible image ring. In this example, FIG. 6A is a plan view of the image ring and shows a first set of images 601 arranged in a visible image ring 602, with a second set of images 603 arranged as an invisible, or ‘virtual image ring’ 604.

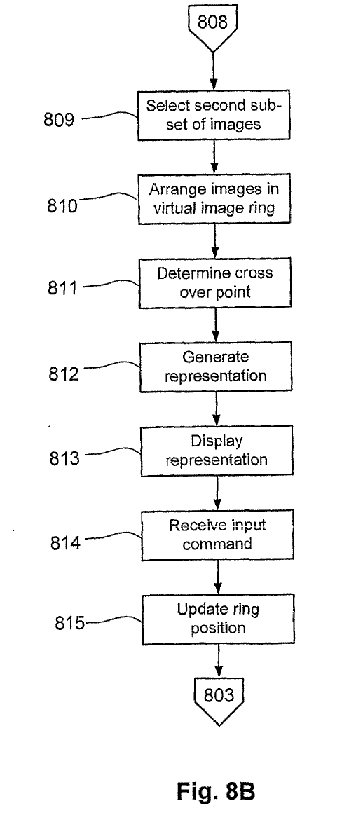

Both the visible image ring 602 and the virtual image ring 604 together contain the entire collection of images being browsed, in a continuous ‘figure 8’ arrangement crossing over at a crossover point 605. Whilst the visible image ring 602 contains up to a maximum number of images, the virtual image ring 604 remaining images, if any, of all images in the collection being browsed.

In this example, as the visible image ring 602 is rotated, as images 601 reach the crossover point, they are transferred into the virtual image ring 604, with a corresponding number of images 603 from the virtual image ring 604 being transferred into the visible image ring 602.

In this example, with the visible image ring 602 rotating in a clockwise direction, as shown by the arrow 607, the flow of images 603 from the virtual image ring 604, is shown at 606.

In this example, with a viewpoint 608 arranged in a fixed alignment with a focus image 609, the crossover point 605 is generally provided on the opposite side of the visible image ring 602, as shown.

FIG. 6B represents an enhancement of the ‘figure 8’ configuration described with reference to FIG. 6A. In this example, arrow 610 represents the direction of rotation of the visible image ring 602. As the visible image ring rotates at a given velocity, the crossover point 605 moves around the visible image ring 602 as shown at 613. The distance the crossover point moves is generally proportional to the direction and velocity of rotation. Arrow 611 represents the apparent offsetting of the virtual image ring 604 to the position indicated by virtual image ring 612.

Viewpoint 608 remains in a fixed alignment with the focus image 609, and accordingly, the new crossover point 613 is no longer opposite to the focus image 609 in the visible image ring 602.

The effect of this is to increase the distance between the cross over point 613 and the position of the focus image 609, and consequently, increase the number of images 601 provided between the crossover point 613 and the position of the focus image 609. This means that more information is provided to the user about the images that they are about to browse to, as opposed to the images that they have already browsed past.

Additionally, with a greater distance for the images 601 to travel, there is a corresponding increase in the length of time taken to travel from the cross over point 613 to the position of the focus image 609 than would otherwise be the case for the same rotational velocity. This can be used to counteract increases in the rotational velocity of the image ring 602, thereby ensuring the images 601 are visible for a sufficient length of time to allow the user to visually recognise the image.

In a further enhancement of the ‘figure 8’ arrangement, the number of images 601 in the visible image ring 602 may be altered in proportion to the total number of images. This can be used to provide a representative view of the number of images in the collection without the need to include all images from the collection in the visible image ring 602.

A logarithmic function for mapping total images to visible image is advantageous since it results in a decreasing growth of the visible image ring as the number of images in the collection grows.

The ratio between the width and height of an image is commonly referred to as its ‘aspect ratio’. A common property of images is that within any collection there is likely to be a range of different sizes and aspect ratios, especially when the images are oriented so that their content is suitable for viewing.

For example, considering photographs, it is common for a photographer to orient the camera in either ‘landscape’ (or ‘wide’) orientation for certain types of images or in ‘portrait’ (or ‘tall’) orientation for other types of images. Additionally, ‘panoramic’ (very wide) images may exist within a collection, video images often have a different aspect ratio compared to still images, and a user may crop or resize images to any particular size or aspect ratio depending on the content of the image and their own preference.

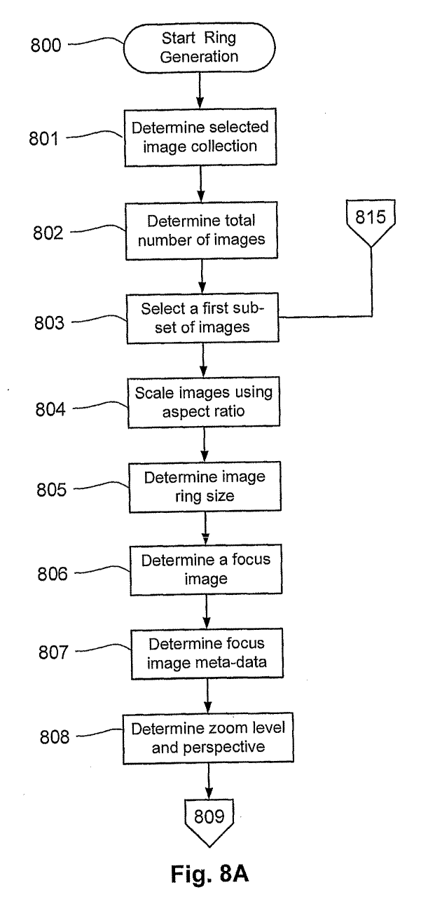

In one example, images are scaled such that they have a fixed height and a variable width according to the aspect ratio of the image. An example of this will now be described with reference to FIG. 7, in which it is assumed that the image ring 204 is arranged around a vertical central axis.

In this example, the image ring 204 is comprised of images including a landscape image 701 and a portrait image 702, where both images are scaled such that they are the same height. Gaps between adjacent images 703, 704 and 705 are equally sized, not accounting for the effects of perspective.

In this arrangement the width of each image is variable depending on its aspect ratio. Consequently the circumference of the visible image ring 204 required to fit a given number of images will depend on widths and hence the aspect ratios, of all of the images in the visible image ring 204.

In one example of the invention, the diameter of the visible image ring is therefore continually adjusted in order to fit a given number of images according to their aspect ratios. Thus, for example, if a ‘figure 8’ arrangement is used, and a portrait aspect ratio image is removed from the image ring 204 and replaced with a landscape aspect ratio image, there will be a corresponding increase in the size of the image ring.

Furthermore the zoom factor, position and tilt angle of the virtual camera 300 can be adjusted such that the visible image ring 204 fits wholly within the view pane 202 in the zoomed out state, given any variation in circumference of the visible image ring.

In an alternate embodiment the number of images shown in the visible image ring is varied according to the average aspect ratio of the images, thereby allowing the circumference of the visible image ring to be maintained within a smaller range of values. By also adjusting the size of the gaps between the images in the visible image ring by a small amount, it would be possible to maintain a fixed diameter of the image ring given any combination of aspect ratios in the visible image ring.

An example of the process of generating and displaying the image ring 204 will now be described in more detail with respect to FIGS. 8A and 8B.

At step 800 the image ring generation process is commenced. Initially, at step 801, the CPU 102 operates to determine a selected image collection. It will be appreciated that this may be achieved in a number of manners depending on the preferred implementation and may include for example having the user operate the control device 105 to select an appropriate image collection.

At step 802 the CPU 102 determines the total number of images in the image collection and then uses this to select a first subset of images collection that are to be displayed in the visible image ring 602, at step 803. The first subset of images can include the entire image collection but typically includes only some of the images, with the number of images selected being determined in any one of a number of ways. Thus, for example, this could include selecting a proportion of the total number of images in the image collection, be set based on threshold levels, chosen using a logarithmic scale, or the like.

At step 804 the CPU 102 operates to scale images using the aspect ratio as described with respect to FIG. 7, before calculating an image ring circumference based on the width of each of the scaled images, at step 805.

At step 806 the CPU 102 determines a current focus image 609. When the image ring 602 is first displayed, this may be an arbitrary selection, or correspond, for example, to the first image in the image collection. In the event that the image ring is being rotated, this will depend on the previously displayed focus image and the direction of image ring rotation.

In any event, at step 807, the CPU 102 determines metadata corresponding to the focus image, before determining viewing properties, such as a zoom level and viewing perspective, at step 808. Thus, this corresponds to selecting the position of the camera 300, and may also include determining the relative visibility of images in a rear portion of the image ring. These parameters are defined based on current image ring control operations, such as the current rotational velocity of the image ring, which is determined as will be described in more detail below.

At step 809 the CPU 102 selects a second subset of images, which usually corresponds to remaining images in the image collection. The second subset of images are then arranged in the virtual image ring 604, at step 810, before the CPU 102 operates to determine a position for the cross over point at step 811.

At step 812 the CPU 102 generates the representation including the visible image ring 602 and causes this to be displayed at step 813 by transferring appropriate signals to the display 100.

At step 814 the CPU 102 operates to receive input commands from the control device 105 before operating to update the ring position at step 815.

At this point, the process returns to step 803 with the CPU 102 operating to determine a new first subset of images for inclusion in the image ring. It will be appreciated that this is determined on the basis of images passing through the cross over point and effectively being transferred between the first and second subset of images.

The manner in which user inputs can be used to manipulate the representation of the image ring, for example, by rotating the image ring, will now be described in more detail.

In particular, FIG. 9A shows an example of a control device that enables a user to control the rotation, camera position and zoom factor of the user interface. The control device 115 includes at least two direction control buttons 901 and 902 and/or a dial 903.

In one example, the operation of button 901 causes the image ring 204 to rotate in an anti-clockwise direction when viewed from above, thereby moving the images 203 that are located to the left of the focus position 206 towards the focus position. Conversely the operation of button 902 causes the image ring 204 to rotate in a clockwise direction when viewed from above, thereby moving the images 203 that are located to the right of the focus position 206 towards the focus position.

Each of the direction control buttons 901 and 902 can be operated in two modes.

In the first mode, the operation of the respective button 901, 902 results in the rotation of the image ring 204 by the exact distance of one image per button press, in the direction associated with the button. In this first mode (‘mode 1’), operation of either button has no effect on the zoom factor or position of the virtual camera.

In the second mode (‘mode 2’), operation of the respective button results in the acceleration and deceleration of the rotation of the image ring, in the direction associated with the button. In this second mode, operation of the either button also causes changes to the zoom factor and position of the virtual camera. Whether the respective button operates in the first or second mode is dependant on the time between when the button is pressed and when it is subsequently released.

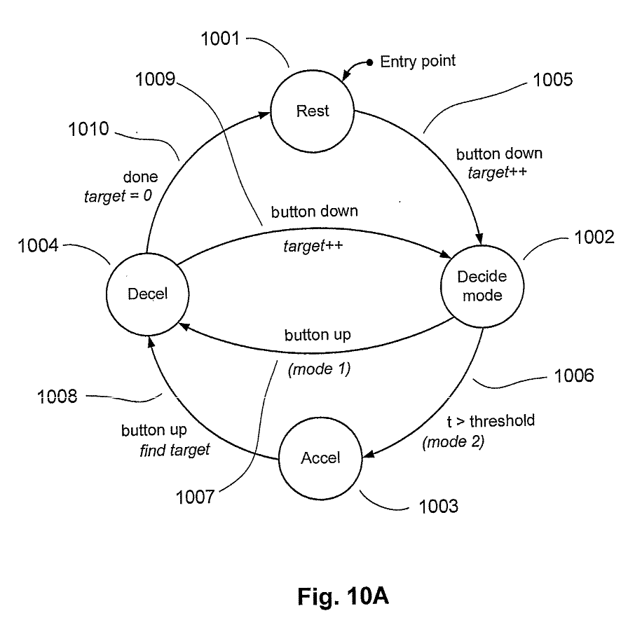

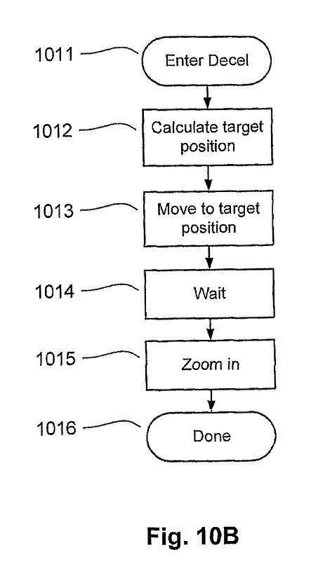

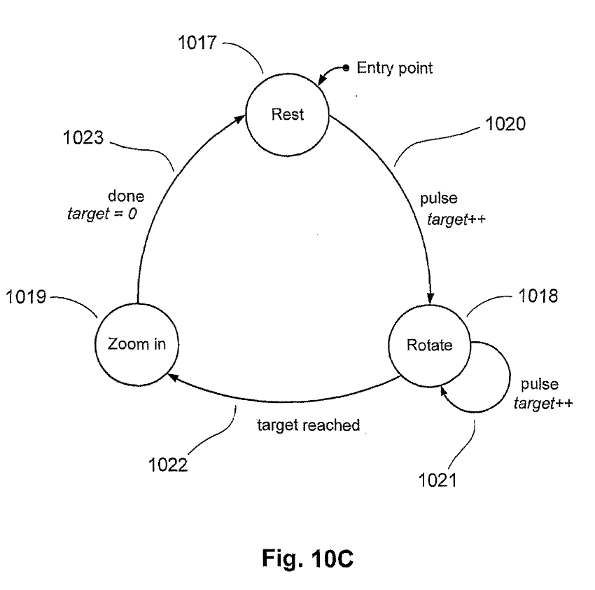

FIG. 10A is a state transition diagram describing the control of the user interface 110 using the direction control buttons 901, 902. The process is entered at state 1001 ‘Rest’, when the user interface 110 is at rest. In this state the image ring 204 is stationary, with the user interface 110 in the zoomed in state shown in FIG. 2C. This generally corresponds to step 813, when the image ring 204 is first displayed.

Transition 1005, to a ‘Decide mode’ 1002, is triggered by the pressing down of a direction control button, 901 or 902. During transition 1005 a target count is incremented by one, as shown at target++. The target count is the number of images that the image ring is to be moved by in the direction associated with the button being pressed. The target count is only relevant for mode 1, however at the time of transition 1005 it is unknown whether mode 1 or mode 2 will become active. The target count is decremented each time the focus image 205 changes, regardless of which state the system is in at that time.

At state 1002 ‘Decide mode’ the CPU 102 waits to determine whether to enter mode 1 or mode 2. At state 1002 a predetermined starting velocity is applied to commence rotation of the image ring 604. This ensures that an immediate response is provided to the user.

As this occurs, it will be appreciated that the CPU 102 repeatedly performs steps 803 to 815, thereby causing the representation to be updated in accordance with the current ring velocity.

Two exit transitions 1006, 1007 are provided from state 1002, with these corresponding to mode 2 and mode 1 respectively. Transition 1006 is triggered when the time since entering state 1002 exceeds a predetermined time threshold. The time threshold represents a distinction between a momentary ‘press’ of a button and an extended ‘press and hold’ of a button by the user. In one example the default time threshold is 300 ms, however it can be adjusted according to individual user preference.

Transition 1007 is triggered when the button is released. Should transition 1007 occur before transition 1006, i.e. the button is released before the time threshold is exceeded, state 1004 ‘Decel’ is entered corresponding to mode 1.

Otherwise, if the hold time t exceeds a threshold, such that t>threshold, state 1003 ‘Accel’ is entered corresponding to mode 2. In this instance, the CPU 102 steadily increases the rotational velocity of the image ring 204 up to a predetermined maximum velocity. It will be appreciated that this is again achieved by having the CPU 102 repeatedly perform steps 803 to 815, allowing the representation to be updated to reflect image ring rotation.

During this process, the zoom level is steadily decreased until the zoomed out state shown in FIG. 2A is reached. As the zoom level decreases, the zoom factor and position of the virtual camera 300 are simultaneously altered at a predetermined rate. Although the acceleration of rotation and decrease in zoom level begin simultaneously upon entering state 1003, they do not necessarily reach their limits at the same time, and hence there is no direct relationship between the zoom level and the velocity of rotation.

Transition 1008 is triggered by the release of the direction control button. This causes state 1004 ‘Decel’ to be entered. In addition, during transition 1008 a target image representing the next focus image 205 is found. In one example, the target image is determined as the next image 203 in the image ring 204 that is not past the focus position 206 at the point in time that transition 1008 is triggered, in the current direction of rotation.

FIG. 10B is a flow chart of events that occur once state 1004 ‘Decel’ is entered.

Step 1012 ‘Enter Decel’ is the starting point of the flow chart and corresponds with the entering of state 1004. At step 1013 the target position is calculated. The target position is the rotational position of the image ring 204 where the target image 203 is exactly aligned with the focus position 206. The target image is either calculated during transition 1008 as described above, or in the case of mode 1 operation is calculated by offsetting the index of the last focus image 205 by the target count.

At step 1013 the rotation of the image ring is accelerated until past the half way distance towards the target position if required, then decelerated over a predetermined time period until the target position is reached.

At step 1014, there is a short pause of predetermined length. At step 1015, the zoom level is steadily increased back to the zoomed in state, over a predetermined time period. At step 1016, the process is complete and a trigger is issued corresponding with transition 1011, causing state 1001 ‘Rest’ to be entered once again. Also during transition 1011 the target count is reset to zero as indicated by target=0.

If a directional control button is pressed while the system is in state 1004 ‘Decel’, transition 1009 is triggered and state 1002 ‘Decide mode’ is re-entered. During transition 1009 the target count is incremented. Continuous pressing and releasing of a directional control button without allowing the system to return to state 1001 ‘Rest’ will result in a loop between states 1002, 1004 and/or 1003, with each button press incrementing the target count and hence determining the eventual target image.

Accordingly, each time a directional button is pressed and rapidly released, the image ring 204 will rotate in a selected direction to bring the next image into the focus position 206. During this, there is no change in the zoom level or viewing perspective.

In contrast, if the directional buttons 901, 902 are held down, for a time t greater than a threshold this causes the image ring 204 to undergo increasing acceleration until a predetermined velocity is reached. During this process, and on the basis of the length of time the button is pressed, the position of the camera 300 moves from 303 to 301, such that the zoom level and viewing perspective change accordingly.

When the directional buttons are released, the image ring decelerates until the velocity reaches zero, with an image 203 is provided in the focus position. During this process the zoom level and viewing perspective also return to the state represented by the camera position 303. This is performed based on the length of time since the button is released.

Thus, the user can use the directional buttons to scroll to a next image 203 in the image ring 204 by using a short duration button press. Alternatively, the user can hold the button 901, 902 down to accelerate the image ring 204 up to a maximum velocity. During this, the viewing perspective shifts, and the zoom level decreases, allowing users to view a larger number of images 203 in the image ring 204. This allows the user to assess when an image of interest is approaching the focus position 206, and consequently release the button 901, 902, allowing the image ring 204 to decelerate to a position in which the image of interest is provided in the focus position 206.

During the acceleration or deceleration phase, the user can release the button 901, 902 and then repeatedly press the button 901, 902. This causes the CPU 102 to enter mode 1 and advance the ring, at the current velocity, each time the button 901, 902 is pressed. In addition to this, if the button is repeatedly pressed, the current zoom level and viewing perspective are maintained.

Thus, this allows two directions buttons 901, 902 to easily manipulate the image ring allowing images of interest to be selected. In particular, the user can press the directional button until a desired viewing perspective and zoom level is reached, allowing images 203 throughout the image ring 204 to be viewed. The user can then use multiple short duration button presses to keep the image ring 204 rotating at the desired viewing perspective and zoom level until an image of interest is approaching the focus position. At this stage, the button can be released, allowing the image ring 2004 to decelerate and stop with the image of interest presented in the focus position.

This therefore allows users to intuitively navigate through a large image collection using only basic navigational buttons 901, 902.

An alternative to using the directional buttons 901, 902 will now be described.

In particular, as shown in FIG. 9A, a dial 903 is provided, which causes the image ring to rotate in a corresponding direction at an angular velocity that is proportional to the angular velocity of rotation of the dial 903.

As the dial is rotated a series of command pulses are sent to the CPU 102, each command pulse corresponding to a predetermined change in angular position of the dial 903. In one example, each command pulse results in the incrementing of the target image by one in the corresponding direction.

However it also possible to map command pulses to images using other ratios, or to map command pulses to changes in rotational angle of the image ring rather than to a specific number of images.

An example of a state transition diagram describing the control of the user interface by the dial 903 is shown in FIG. 10C.

At state 1017 ‘Rest’, the user interface 110 is at rest, with the image ring motionless, and in the zoomed in state as shown in FIG. 2C. Transition 1020 is triggered by a command pulse from the rotation of the dial 903, and state 1018 ‘Rotate’ is entered. At the same time, the target count is incremented in the relative direction of rotation of the dial. At state 1018, a target image is calculated by offsetting the index of the last focus image by the target count; and a target position is calculated from the target image. The rotational position of the image ring is accelerated towards the target position. Also at state 1018, a zoom level is calculated based either on the current velocity of rotation of the image ring 204 or alternatively, on the frequency of command pulses from the rotation of the dial 903. A zoom factor may also be used. The position of the virtual camera 300 is also set according to the calculated zoom level. Both the rotational velocity and zoom level are bounded by maximum values which are predetermined.

Transition 1021 is triggered by a subsequent command pulse from the operation of the dial. State 1018 ‘Rotate’ is reentered after transition 1021. At the time of transition 1021 the target count is incremented in the relative direction of rotation of the dial.

Transition 1022 is triggered when the position of the image ring reaches the target position and no further rotation of the image ring 204 is necessary. At this point the system enters state 1019 ‘Zoom in’. After a predetermined delay, the zoom level is steadily increased back to the zoomed in state, over a predetermined time period, with a trigger being issued corresponding to transition 1023, causing state 1017 ‘Rest’ to be entered once again.

When the dial control 903 is used, continual changes in the rotational velocity of the image ring 204 can occur due to fluctuations in the rotational velocity of the dial 903 by the user. Since, in this example, the zoom level is calculated based on the rotational velocity of the image ring 204, this would result in continuous changes to the zoom level which could be visually disturbing to the user. Accordingly, a dampening function can be applied to changes in the zoom level.

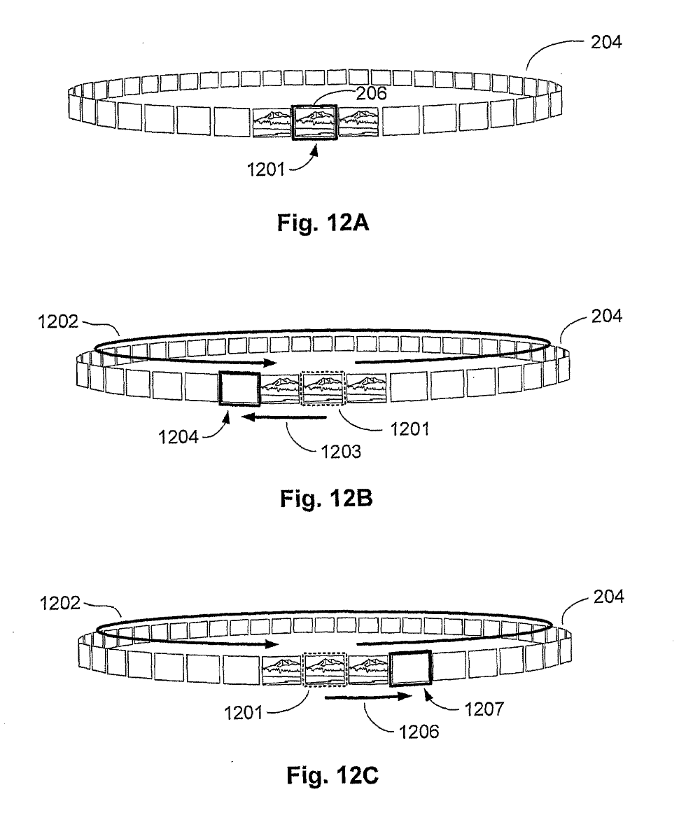

FIG. 12 is a function graph illustrating the zoom level dampening function of one example of the invention. In this example, axis 1101 represents the rotational velocity of the image ring 204, whilst axis 1102 represents the resulting zoom level.

Value 1103 represents the pre-defined minimum zoom level and value 1104 represents the pre-defined maximum zoom level. Value 1105 represents the current zoom level, which may fall at any point between values 1103 and 1104, and is shown at the value 1105 for the purpose of example only. Curve segment 1106 represents the maximum value of the function corresponding to the maximum zoom level and curve segment 1111 represents the minimum value of the function corresponding to the minimum zoom level.

Curve segment 1108 represents the current zoom level. This is a flat segment in the curve where dimensions 1112 and 1113 each represent a predefined dampening threshold, with the total length of the curve segment 1108 being equal to two times the dampening threshold. The velocity must vary beyond the bounds of the curve segment 1108 before any change in zoom level can occur. Therefore for small changes in velocity the rotational velocity of the image ring 204 the zoom level will remain constant.

Curve segment 1107 represents a steady increase in the zoom level as the velocity decreases outside of the region covered by curve segment 1108 (and greater than the region covered by the maximum zoom level curve segment 1106). Curve segment 1109 represents a steady decrease in the zoom level as the velocity increases outside of the region covered by curve segment 1108 (and less than the region covered by the minimum zoom level curve segment 1111).

Each time the zoom level is recalculated, which occurs when the state 1018 ‘Rotate’ of FIG. 10C is entered, if the newly calculated zoom level falls on either segment 1107 or segment 1109, the level of the value 1105 is set to the newly calculated zoom level. The curve segment 1108 is also adjusted such that the midpoint of the curve segment 1108 on axis 1101 is located at the newly calculated rotational velocity of the image ring.

Curve segments 1107 and 1109 are then recalculated according to the endpoints of the curve segment 1108, and the fixed minimum and maximum curve segments 1111 and 1106 respectively.

In alternate embodiments, other dampening methods can be applied to the zoom level for example a low pass filter on the frequency of change of the rotational velocity.

In this example, the user can therefore commence rotation of the dial 903, with the rate of rotation controlling both the rate of rotation of the image ring 204, as well as the zoom level and viewing perspective position. As image ring 204 rotates, and the user sees an image 203 travelling towards the focus position 206, the user can stop rotation of the dial, with the image ring decelerating until an image is provided in the focus position. In the event that this is not the image of interest, the user can then make further adjustments as required.

A further alternative example of a control device 105 is shown in FIG. 9B. In this example, a jog dial 904 is provided, which causes the ring to rotate at an angular velocity that is proportional to the rotational displacement of the position indicator 905 of the jog dial from the centred position 906. The maximum rotational displacement of the jog dial in the anti-clockwise and clockwise directions respectively is indicated by positions 907 and 908. These positions correspond to the maximum rotational velocity of the image ring 204 in the anti-clockwise and clockwise directions respectively.

Alignment of the position indicator 905 of the jog dial 904 with the centred position 906 is normally maintained by a spring mechanism, whereby the dial is returned to the centred position upon release of operational force by the user of the dial. The centred position corresponds to zero velocity of rotation of the image ring 204.

It will be appreciated that this can function in a manner similar to that described above, with the control device 105 generating command pulses that are sent to the CPU 102, each command pulse being based on a change in the current angular position of the dial 905.

In this example, the CPU 102, upon receiving a command pulse, will cause the image ring to rotate at a predetermined velocity, given by the angular position of the dial. In absence of further command pulses, this indicates to the CPU 102 that the current angular position of the dial 905 is being maintained and consequently, the image ring continues to rotate at the current velocity. In the event that the dial 905 is moved, the CPU 102 uses the resulting command pulse to determine a new rotational velocity and manipulate the image ring rotation accordingly.

It will be appreciated that in this example, a damping function similar to that shown in FIG. 12 can be used to prevent minor variations in the position of the dial 905 from unduly affecting the rotational velocity of the image ring.

In the above mentioned examples, when the image ring 204 is rotating, there will generally be a delay in the reflexes of the user between the time the user sees the image and the time they release the direction control button 901, 902 or stop rotating the dial 903. In addition there may be some delays built into the system such as the predetermined deceleration time as described above with reference to FIG. 10B, step 1013. The combined effect of these delays is herein referred to generally as ‘focus lag’.

To reduce the effects of focus lag, the position of the focus indicator 206 can be varied as will now be described.

In particular, FIG. 12A shows an example in which the image ring 204 has a focus indicator 206 provided at the normal focus position, as shown at 1201.

In FIG. 12B, rotation of the image ring 204 is indicated by arrow 1202, with the position of the focus position being moved to 1204 as indicated by the arrow 1203. In this example, the direction of movement of the focus position to 1204 is in the opposite direction to the direction of rotation 1202 and a distance that is dependent on the velocity of rotation of the image ring 204. As the rotational velocity of the image ring is reduced, the focus position gradually moves back towards the normal focus position 1201, which it reaches by the time that the rotational velocity of the image ring is zero.

In this example, deceleration of the image ring 204 and the return of the focus position 206 to its normal position 1201 occur simultaneously. As a result, the actual image 203 that becomes the focus image 205 upon initiating the deceleration of the image ring 204 is offset in the direction opposite to the direction of rotation of the image ring 204. In other words, the image 203 provided in the focus position 1204 when the user initiates image ring deceleration, will end up in the focus position 1201 when the image ring stops rotating. This helps counteract the tendency for the user to overshoot when targeting a focus image 205 as a result of focus lag.

FIG. 12C is another example of counteracting for focus lag. In this example, the focus position is offset to a new position 1207, in the direction of image ring rotation 1202, as shown by the arrow 1206. In this example, as the focus position is offset in the same direction as the rotation of direction of the image ring, the user is given more time to view the images in the front portion 204B of the image ring 204 before they reach the focus position 1207. Thus, the distance between the left-most visible portion of the image ring 204, and the new focus position 1207 is increased when compared to the default focus position 1201.

In this instance, when a control signal is given by the user to stop the rotation of the image ring 204, to thereby to select a focus image 205, the focus position remains substantially at 1207 during the deceleration process. Consequently, an image 203 provided at the default focus position 1201 when deceleration is commenced will continue to move until the modified focus position 1207 is reached. At this time, the image ring 204 and the focus position 1207 rotate in a reverse direction until the focus image 205 is once again provided at the default focus position 1201.

As a result, the user can commence deceleration when the image of interest is provided at the front of the image ring, with the CPU 102, reversing the ring to counteract for movement occurring during the deceleration process, thereby accounting for focus lag.

As compared to the technique described above with respect to FIG. 12B, this has the added advantage of increasing the length of time the image is visible in the front portion 204B of the image ring before deceleration of the image ring 204 is commenced. However, the reversing of the image ring can be visually unappealing, and therefore undesirable in some circumstances.

A further enhancement that can be provided to the user interface 110 is to vary the visible weight of the focus indicator 206 dependent on the velocity of rotation of the image ring 204.

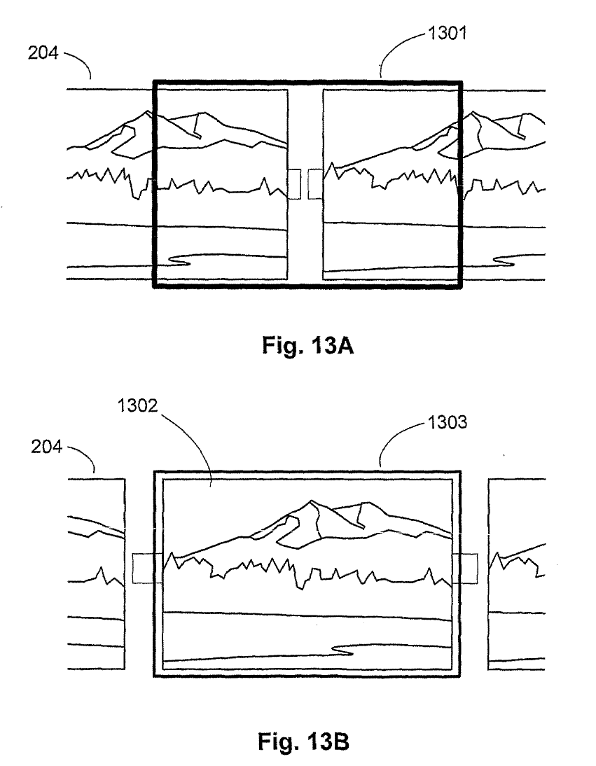

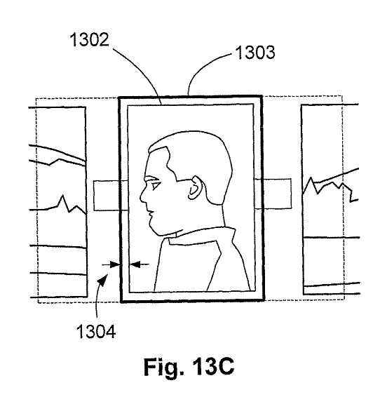

An example of this will now be described with respect to FIGS. 13A and 13B. In FIG. 13A the image ring 204 is rotating at a given velocity, as indicated by the images 203 not being aligned to the focus indicator, which is indicated at 1301. In this example, whilst the image ring 204 is rotating and no focus image is selected, the visual weight of the focus indicator 1301 is heavy, in order to draw more attention to the focus position and to support the user's task of choosing a new focus image 205.

In contrast FIG. 13B shows the image ring 204 stationary, with a focus image 1302 aligned with the focus position, as indicated by the focus indicator 1303. In this example, whilst the image ring 204 is stationary the visual weight of the focus indicator 1303 is lighter, in order to reduce distraction of the user from viewing the focus image 205. In this latter state, since a focus image is already chosen the importance of the focus indicator is diminished.

As an alternative to reducing the visual weight of the focus indicator 1303, the focus indicator can be removed completely when the image ring is stationary, for example by making the focus indicator completely transparent.

Additionally, in the event that the focus indicator 1303 is retained in a visible or partially visible form, it is typical for the dimensions of the focus indicator 1303 to be modified in accordance with the image size. An example of this is shown in FIG. 13C, in which the size of the focus indicator 1303 is modified to correspond to the shape of the portrait orientated focus image 1302. In FIG. 13C, the dimensions of the focus indicator 1303 for a landscape image, as shown for example in FIG. 13B, is shown by the dotted lines for the purpose of comparison.

Resizing of the focus indicator 1303 may be achieved in any one of a number of manners, but is typically performed by having the CPU 102 determine the size of the focus image, and then configure the dimensions of the focus indicator 1303 to be bigger than the focus image size by a predetermined amount. This ensures that the focus indicator 1303 defines a perimeter surrounding the focus image 1302 with a predetermined gap between the focus image and the focus indicator 1303, as shown at 1304.

Accordingly, the above described system provides a mechanism for viewing images in an image collection, and in particular provides a mechanism which allows a user to scan through a number of images by appropriate rotation of the image ring 204. This is achieved using direction controls alone, with the CPU 102 acting to vary the viewing perspective and the zoom level, dependent on the users activation of the rotation controls, thereby ensuring that the presented configuration provides optimal viewing to the user. This in turn allows a user to review an image collection using only basic input commands.

This in turn, makes the system suitable for using with an input device having limited functionality, such as the remote control device 105 described in detail with respect to FIGS. 9A and 9B. As a result, the system is suitable for allowing inexperienced computer uses to review image collections. This advantageously can be achieved using a set-top box, media device 101, or other suitable processing arrangement, coupled to a suitable display device 100 such as a television, thereby obviating the need for a computer system to allow image review.

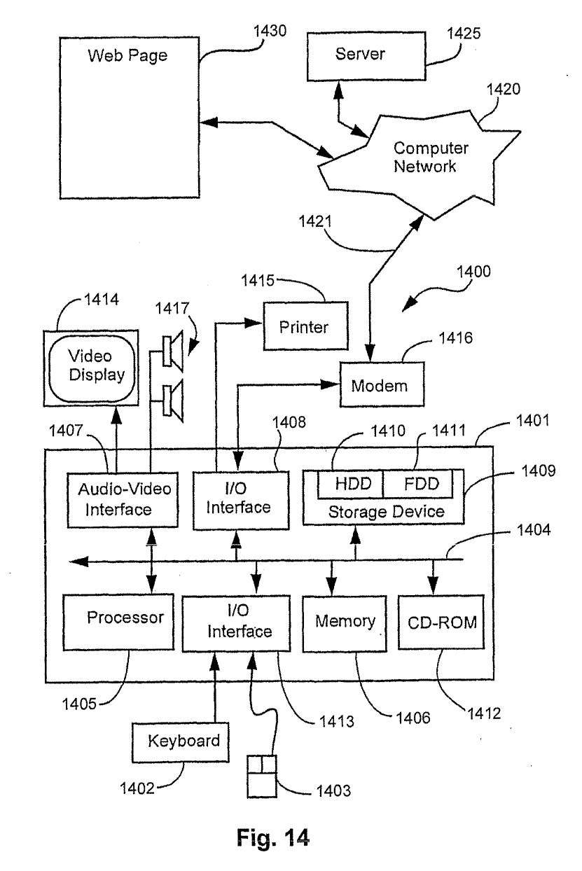

However, it will be appreciated that the techniques can be used with any form of computer system, such as the computer system shown in FIG. 14.

In this example, the computer system 1400 is formed by a computer module 1401, input devices such as a keyboard 1402 and mouse 1403, and output devices including a printer 1415, a display device 1414 and loudspeakers 1417. A Modulator-Demodulator (Modem) transceiver device 1416 is used by the computer module 1401 for communicating to and from a communications network 1420, for example connectable via a telephone line 1421 or other functional medium. The modem 1416 can be used to obtain access to the Internet, the Web, and other network systems, such as a Local Area Network (LAN) or a Wide Area Network (WAN), and may be incorporated into the computer module 1401 in some implementations.

The computer module 1401 typically includes at least one processor unit 1405, and a memory unit 1406, for example formed from semiconductor random access memory (RAM) and read only memory (ROM). The module 1401 can also include an number of input/output (I/O) interfaces including an audio-video interface 1407 that couples to the video display 1414 and loudspeakers 1417, an I/O interface 1413 for the keyboard 1402 and mouse 1403 and optionally a joystick (not illustrated), and an interface 1408 for the modem 1416 and printer 1415. In some implementations, the modem 1416 may be incorporated within the computer module 1401, for example within the interface 1408. A storage device 1409 is provided and typically includes a hard disk drive 1410 and a floppy disk drive 1411. A magnetic tape drive (not illustrated) may also be used. A CD-ROM drive 1412 is typically provided as a non-volatile source of data.

The components 1405 to 1413 of the computer module 1401, typically communicate via an interconnected bus 1404 and in a manner that results in a conventional mode of operation of the computer system 1400 known to those in the relevant art. Examples of computers on which the described arrangements can be practised include IBM-PC's and compatibles, Sun Sparcstations or the like.

The modem 1416 enables a user of the computer 1400 to access content, such as image collections stored on the computer network 1420. The image collections may be resident on a server computer 1425 (shown separately), or hosted on a Web page 1430. This allows the image collections to be accessed via a Web address defined by a Uniform Resource Locator (URL) to thereby allow the image collections to be viewed by the user.

The process of generating the image ring to allow image browsing is typically implemented using software, such as one or more application programs executing within the computer system 1400. Typically, the application causes the processor 1405 to display the user interface 110, including the image ring, on the video display 1414 of the computer system 1400.

In this example, manipulation of the image ring can be controlled using one or more of the input devices, such as the keyboard 1402, or the mouse 1403. However, alternatively other input devices, such as a remote control similar to the remote control device shown in FIGS. 9A and 9B, could be used, with the remote control communicating with the computer system via an appropriate interface, such as the I/O interface 1413. It will be appreciated that in circumstances where a separate input device is provided, communication between the input device and the computer system can be affected wirelessly, for example using infra-red, or limited range radio communications, although wired connections may alternatively be used,

The process of generating and manipulating the image ring is typically affected by instructions in the software that are carried out by the computer system. The instructions may be formed as one or more code modules, or the like. The software may be stored in a computer readable medium, and loaded into the computer, from the computer readable medium, to allow execution. A computer readable medium having such software or computer program recorded on it is a computer program product.

Typically, the software is resident on the hard disk drive 1410 and read and controlled in its execution by the processor 1405. Intermediate storage of the program and any data fetched from the network 1420 may be accomplished using the semiconductor memory 1406, possibly in concert with the hard disk drive 1410. In some instances, the browser program may be supplied to the user encoded on a CD-ROM or floppy disk and read via the corresponding drive 1412 or 1411, or alternatively may be read by the user from the network 1420 via the modem device 1416. Still further, the software can also be loaded into the computer system 1400 from other computer readable media.

Alternatively, however, the software could be implemented in a computer system coupled to the computer network 1420, such as the server 1425. In this instance, input commands received by the processing system 1400 could be transferred to the server 1425, causing the server 1425 to generate and manipulate the image ring, with data representing the resulting user interface 110 being returned to the computer system 1420, allowing the image ring to be displayed locally.

The term “computer readable medium” as used herein refers to any storage or transmission medium that participates in providing instructions and/or data to the computer system 1400 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 1401. Examples of transmission media include radio or infra-red transmission channels as well as a network connection to another computer or networked device, and the Internet or Intranets including e-mail transmissions and information recorded on Websites and the like.

Thus, the presentation of the user interface 110, including the image ring, can be performed by any general purpose processing system, of which the set-top box of FIG. 1A and the computer system of FIG. 14 are example configurations for the purpose of illustration only. Thus, any suitable processing system may be used to provide the functionality described above.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1) A method of browsing images in an image collection, wherein the method comprises, in a processing system, causing a representation of a number of the images to be displayed, the representation including the number of images arranged in an image ring, the image ring having an image ring size determined by at least one of:
a) the number of images; and,
b) the size of images in the image ring.

2) A method according to claim 1, wherein the method includes, in the processing system:
a) selecting the number of images from the image collection;
b) determining the size of each of the selected images; and,
c) determining the image ring size using the size of each selected image.

3) A method according to claim 2, wherein the method includes, in the processing system:
a) generating the representation by arranging the selected images in the image ring in accordance with the determined image ring size; and,
b) transferring representation signals to a display thereby causing the display to display the representation.

4) A method according to claim 1, wherein the method includes, in the processing system:
a) receiving at least one input command via an input device; and,
b) manipulating the representation of the image ring in accordance with the at least one input command.

5) A method according to claim 4, wherein the method includes, in the processing system, manipulating the representation by at least one of:
a) rotating the image ring;
b) altering an image ring zoom level; and,
c) altering an image ring viewing perspective.

6) A method according to claim 5, wherein the method includes, in the processing system, determining the zoom level based on at least one of:
a) a time since a directional control button is actuated; and,
b) a rotational velocity of the image ring.

7) A method according to claim 6, wherein the method includes, in the processing system, applying a dampening function to changes in zoom level in response to changes in the rotational velocity of the image ring.

8) A method according to claim 1, wherein the method includes, in the processing system:
a) receiving input commands via at least one directional control button;
b) rotating the image ring by at least one of:
i) in a first mode, one image per button press; and,
ii) in a second mode, at a rotational velocity dependent on the duration of a button press.

9) A method according to claim 8, wherein the method includes, in the processing system, selecting the operational mode dependent on the elapsed time between depressing and releasing the directional control button.

10) A method according to claim 1, wherein the method includes, in the processing system:
a) receiving input commands via at least one input dial;
b) rotating the image ring by at least one of:
i) a rotational velocity determined at least in part on the rotational velocity of the input dial; and,
ii) a rotational velocity determined at least in part on the rotational position of the input dial.

11) A method according to claim 1, wherein the method includes, in the processing system, altering at least one of a viewing perspective and a zoom level depending on the size of the image ring

12) A method according to claim 1, wherein the representation includes a focus position, and wherein the method comprises:
a) displaying a focus image, the focus image being an image provided at the focus position; and,
b) changing the focus image by rotating the image ring.

13) A method according to claim 12, wherein the method includes, in the processing system, altering the focus position depending on a rotational velocity of the image ring.

14) A method according to claim 12, wherein the focus position is represented by a focus indicator, and wherein the method includes, in the processing system, altering at least one property of the focus indicator depending on relative alignment between an image and the focus indicator.

15) A method according to claim 14, wherein the method includes, in the processing system, altering a focus indicator visibility such that the focus indicator has at least one of:
a) an increased visible weight when the image ring is rotating; and,
b) a reduced visible weight when the focus image is aligned with the focus indicator.

16) A method according to claim 14, wherein the method includes, in the processing system, altering dimensions of the focus indicator in accordance with dimensions of the focus image.

17) A method according to claim 12, wherein the method includes, in the processing system:
a) determining metadata associated with an image provided at the focus position; and,
b) providing the metadata in the representation.

18) A method according to claim 12, wherein the image is a video sequence, and wherein the method includes, in the processing system, and when the video sequence is in the focus position:
a) displaying the image as a moving image sequence; and,
b) providing audio output associated with the image sequence.

19) A method according to claim 1, wherein the method includes, in the processing system:
a) scaling each image such that:
i) a first dimension of each image is constant; and,
ii) a second dimension of each image depends on the aspect ratio of the image; and,
b) generating the representation using the scaled images.

20) A method according to claim 19, wherein the method includes, in the processing system, determining the image ring size based on the second dimension of each image.

21) A method according to claim 19, wherein the method includes, in the processing system, determining the image ring size based on the average aspect ratio of the images in the image ring.

22) A method according to claim 19, wherein the method includes, in the processing system, selecting the number of images based on the average aspect ratio of the images in the image ring.

23) A method according to claim 1, wherein the method includes, in the processing system:
a) determining a second number of images from the image collection;
b) arranging the second number of images in a virtual image ring, the virtual image ring being connected to the image ring at a crossover point, such images are transferred between the virtual image ring and the image ring as the images move through the crossover point.

24) A method according to claim 23, wherein the method includes, in the processing system, adjusting the position of the crossover point depending on a rotational velocity of the image ring.

25) A method according to claim 1, wherein the method includes, in the processing system, altering the number of images in the image ring depending on the total number of images in the image collection.

26) A method according to claim 1, wherein the method includes, in the processing system, displaying the images in the image ring in a common orientation.

27) A method according to claim 1, wherein the method includes, in the processing system, reversing images as the images are transferred between front and back portions of the image ring.

28) A method according to claim 1, wherein the method includes, in the processing system, altering at least one image property depending on at least one of:
a) a position of the image in the image ring; and,
b) a rotational velocity of the image ring.

29) A method according to claim 28, wherein the at least one image property includes at least one of:
a) an image opacity; and,
b) an image obscurity.

30) Apparatus for browsing images in an image collection, wherein the apparatus includes a processing system for causing a representation of a number of the images to be displayed, the representation including the number of images arranged in an image ring, the image ring having an image ring size determined by at least one of:
a) the number of images; and,
b) the size of images in the image ring.

31) Apparatus according to claim 30, wherein the apparatus includes an input device, the processing system being for:
a) receiving at least one input command via an input device; and,
b) manipulating the representation of the image ring in accordance with the at least one input command.

32) Apparatus according to claim 31, wherein the input device communicates wirelessly with the processing system.

33) Apparatus according to claim 32, wherein the input device is a remote control.

34) Apparatus according to claim 33, wherein the input device includes, at least one of:
a) a first input button for causing the processing system to rotate the image ring in a first direction;
b) a second input button for causing the processing system to rotate the image ring in a second direction; and,
c) an input dial for causing the processing system to rotate the image ring at a velocity determined by the rate of rotation of the dial; and,
d) an input dial for causing the processing system to rotate the image ring at a velocity determined by the rotational position of the input dial.

35) Apparatus according to claim 30, wherein the processing system is for transferring representation signals to a display thereby causing the display to display the representation, the display being a television.

36) Apparatus according to claim 30, wherein the apparatus performs the method of claim 1.

37) A computer program product for browsing images in an image collection, the computer program product being formed from computer executable code which when executed on a suitable processing system causes a representation of a number of the images to be displayed, the representation including the number of images arranged in an image ring, the image ring having an image ring size determined by at least one of:
a) the number of images; and,
b) the size of images in the image ring.

38) A computer program product according to claim 37, wherein the computer program product causes the processing system to perform the method of claim 1.
